(19) United States
(12) Patent Application Publication
(10) Pub. No.: US 2010/0219642 A1
(43) Pub. Date: Sep. 2, 2010

(54) WIND TURBINE WITH SINGLE MAIN BEARING

(75) Inventors: Doo-hoon Kim, Chungcheongnam-do (KR); Ji-yoon Ryu, Chungcheongnam-do (KR); Jo-hyug Bang, Gwangju (KR); Dae-hyun Kim, Chungcheongnam-do (KR); Chung-hwan Chun, Gleichen (DE); Chin-wha Chung, Gyeongsangbuk-do (KR); Kyung-seop Han, Gyeongsangbuk-do (KR); Young-chan Kim, Gyeongsangbuk-do (KR)

Correspondence Address: OBLON, SPIVAK, MCCLELLAND MAIER & NEUSTADT, L.L.P., 1940 DUKE STREET, ALEXANDRIA, VA, 22314, US

(73) Assignee: UNISON CO., LTD., CHEONAN-SI (KR)

(21) Appl. No.: 11/993,150

(22) PCT Filed: Apr. 9, 2007
(86) PCT No.: PCT/KR2007/001717

§ 371 Date: Dec. 19, 2007

(30) Foreign Application Priority Data
Apr. 14, 2006 (KR) 10-2006-0034157

(51) Int. Cl. F03D 9/00; F03D 11/02

(52) U.S. Cl. 290/55; 416/170 R

(57) ABSTRACT

Disclosed is a wind turbine comprising a nacelle frame provided with one main bearing on the front surface thereof; a rotor including a rotor hub provided with a hollow drum shaft, installed on the inner ring of the main bearing, at the rear thereof; an acceleration gear box including an input shaft, connected to the tip of the hollow drum shaft, at the front portion thereof and an output shaft at the rear portion thereof, and floating in the nacelle frame under the condition that the acceleration gear box is separated from the nacelle frame for increasing the rotational speed of the input shaft and transmitting the rotation of the input shaft to the output shaft; a torque supporter installed between the acceleration gear box and the nacelle frame for preventing the acceleration gear box from self-rotating; and a generator including a rotary shaft connected to the output shaft.

### TECHNICAL FIELD

The present invention relates to a wind turbine, and more particularly to a wind turbine with a single main bearing, in which an acceleration gear box is assembled with a nacelle frame under the condition that the acceleration gear box is separated from the nacelle frame using one main bearing, and thus only rotary torque generated from a rotor is transmitted to the acceleration gear box and load of the rotor, except for the rotary torque, is supported by the main bearing and transmitted to the nacelle frame, so as to improve the durability and efficiency of the acceleration gear box.

### BACKGROUND ART

Generally, wind turbines generate electricity by rotating a shaft of a generator using the rotary power of a windmill, which is rotated by natural wind.

As shown in FIG. 9, a conventional wind turbine includes a tower 1 fixedly installed at a designated height above the ground, a nacelle frame 2 installed at the upper end of the tower 1 and rotated in the direction of wind, a rotor 3 installed at the front end of the nacelle frame 2 and including a rotor hub 3b and a plurality of blades 3a connected to the rotor hub 3b, a rotary shaft 4 connected to the rotor 3 and supported by two main bearings 4a, a generator 5 installed at the rear end of the nacelle frame 2, and an acceleration gear box 6 installed between the rotary shaft 4 and the generator 5 for increasing the rotational speed of an input shaft of the generator 5.

The acceleration gear box 6 of the wind turbine has a structure that the acceleration gear box 6 is accelerated in three stages, and includes an output shaft rotated at a high speed. The generator 5 is a doubly-fed induction generator.

The above conventional wind turbine has several problems, as follows.

The above conventional wind turbine rotates the generator at a high speed through a high acceleration ratio using the acceleration gear box 6, which is accelerated in three stages, thus generating problems, such as shortening of fatigue lives of parts including bearings provided in the acceleration gear box, fatigue damage to teeth of gears provided in the acceleration gear box due to wearing away of the teeth, and high noise and vibration of the acceleration gear box.

Further, as shown in FIG. 10, another conventional wind turbine includes a rotor 100 having a rotor hub 100a with which blades are assembled, a planetary holder 200 installed at the rear portion of the rotor hub 100a and having a carrier plate 201 at the tip thereof, a ring gear 300 assembled with an inner ring of a roller bearing 301 and assembled with a gear box 600 so as not to be rotated, planetary gears 400 engaged with the inside of the ring gear 300 and rotatably provided on a bogie shaft 401, a sun gear 500 engaged with the planetary gears 400, the gear box 600 provided with the ring gear 300 installed at the front end thereof and the planetary gears 400 installed therein, and having an output shaft 601 at the tip thereof, and a nacelle frame 700, in which the gear box 600 is installed.

In the above conventional wind turbine, when the rotor 100 is rotated by wind and then the rotor hub 100a is rotated, the planetary holder 200 installed on the rotor hub 100a is rotated under the condition that the planetary holder 200 is supported by the roller bearing 301. As the planetary holder 200 is rotated, the carrier plate 201 is rotated in the ring gear 300 and pushes the bogie shaft 401 so that the circular movement of the bogie shaft 401 is carried out in the ring gear 300. As the circular movement of the bogie shaft 401 is carried out, the planetary gears 400 engaged with the inside of the ring gear 300 are rotated along the inner surface of the ring gear 300. That is, the circular movement of the planetary gears 400 is carried out in the ring gear 300.

As the circular movement of the planetary gears 400 is carried out, the sun gear 500 engaged with the planetary gears 400 is rotated and accelerated in one stage, and a spur gear (not shown) provided in the gear box 600 is rotated by the sun gear 500 and accelerated in multi-stages. Thereafter, a shaft of a generator (not shown) is rotated at a high speed through the output shaft 601.

The above conventional wind turbine has several problems, as follows.

Since a structure between the rotor hub 100a and the sun gear 500 is complicated and the planetary holder 200, the ring gear 300, and the planetary gears 400 are installed at the outside of the nacelle frame 700, the wind turbine is not easily assembled and disassembled, thus causing difficulties in replacing parts and maintaining and repairing parts.

Since the gear box 600 is firmly installed directly in the nacelle frame 700, external force transmitted through the nacelle frame 700 is directly transmitted to the gear box 600, and thus the gear box 600 has a reduced durability and generates serious noise and vibration.

When the gear box 600 installed in the nacelle frame 700 is replaced with a new one due to a malfunction, all parts including the rotor 100 disposed in front of the gear box 600 must be disassembled, thus causing a difficulty in maintaining and repairing the gear box 600.

### DISCLOSURE

### Technical Problem

Therefore, the present invention has been made in view of the above problems, and it is an object of the present invention to provide a wind turbine with a single main bearing, in which an acceleration gear box is assembled with a nacelle frame under the condition that the acceleration gear box is separated from the nacelle frame using one main bearing, and thus only rotary torque generated from a rotor is transmitted to the acceleration gear box and load, except for the rotary torque, is transmitted from the rotor to the nacelle frame through the main bearing, so as to improve the durability of the acceleration gear box.

It is another object of the present invention to provide a wind turbine with a single main bearing, in which it is possible to effectively prevent an acceleration gear box from self-rotating through a simple structure so as to reduce the vibration of the acceleration gear box.

It is another object of, the present invention to provide a wind turbine with a single main bearing, in which the transmission of rotary force between a generator and a nacelle frame is stably and precisely achieved.

It is another object of the present invention to provide a wind turbine with a single main bearing, which the acceleration, i.e., the increase of the number of rotations, is stably and effectively achieved through a planetary gear.

It is another object of the present invention to provide a wind turbine with a single main bearing, in which housings of an acceleration gear box and a generator are formed integrally so as to stably transmit rotary force without any separate shaft coupling unit and simply install and assemble the acceleration gear box and the generator.

It is yet another object of the present invention to provide a wind turbine with a single main bearing, in which vibration between a generator and a nacelle frame is not transmitted.

### Technical Solution

In accordance with an aspect of the present invention, the above and of the objects can be accomplished by the provision of a wind turbine with a single main bearing, comprising a nacelle frame provided with one main bearing on the front surface thereof; a rotor including a rotor hub provided with a hollow drum shaft, installed on the inner ring of the main bearing, at the rear thereof; an acceleration gear box including an input shaft, connected to the tip of the hollow drum shaft, at the front portion thereof and an output shaft at the rear portion thereof, and floating in the nacelle frame under the condition that the acceleration gear box is separated from the nacelle frame for increasing the rotational speed of the input shaft and transmitting the rotation of the input shaft to the output shaft; a torque supporter installed between the acceleration gear box and the nacelle frame for preventing the acceleration gear box from self-rotating; and generator including a rotary shaft connected to the output shaft.

The acceleration gear box further includes a gear housing connected to the other end of the input shaft; a planetary gear eccentrically and rotatably connected to the inner surface of the gear housing; an internal gear, the inner surface of which is engaged with the outer surface of the planetary gear so that the planetary gear is rotated together with the rotation of the gear housing; and a gear shaft provided with one end engaged with the inner surface of the planetary gear and the other end connected to the output shaft; and is accelerated in a first stage by the planetary gear.

The acceleration gear box further includes a connection gear connected to the tip of the gear shaft; and an acceleration gear installed at the front end of the output shaft so as to be engaged with the connection gear and be accelerated; and is accelerated in a second stage by the acceleration gear.

The torque supporter includes torque levers protruded from both side surfaces of the acceleration gear box and fixed to the nacelle frame; and vibration absorbing dampers assembled with the torque levers so as to prevent the vibration of the acceleration gear box from being transmitted to the nacelle frame.

The vibration absorbing dampers are made of synthetic rubber so as to reduce the transmission of the vibration generated from the acceleration gear box to the nacelle frame.

The wind turbine further comprises a shaft coupling unit installed between the output shaft and the rotary shaft so as to achieve the transmission of rotary force therebetween under the condition that an angle of deviation is allowed.

The acceleration gear box and the generator are integrally formed such that housings of the acceleration gear box and the generator are assembled integrally and installed in the nacelle frame.

The generator further includes generator dampers installed between the lower surface of the generator and the upper surface of the nacelle frame so as to prevent vibration from being transmitted between the nacelle frame and the generator.

The main bearing is a double-row taper roller bearing.

The generator is a permanent magnet synchronous generator.

The hollow drum shaft includes a support protrusion protruded from the front end of the outer circumferential surface thereof so as to support the inner ring of the main bearing.

### DESCRIPTION OF DRAWINGS

The above and other objects, features and other advantages of the present invention will be more clearly understood from the following detailed description taken in conjunction with the accompanying drawings, in which:

FIG. 1 is a longitudinal-sectional view of an essential portion of a wind turbine in accordance with one embodiment of the present invention;

FIG. 2 is a transversal-sectional view of the essential portion of the wind turbine in accordance with one embodiment of the present invention;

FIG. 3 is a sectional view of an essential portion of a main bearing in accordance with one embodiment of the present invention;

FIG. 4 is a longitudinal-sectional view of an essential portion of an acceleration gear box of the wind turbine of FIG. 1;

FIG. 5 is a longitudinal-sectional view of an essential portion of a wind turbine in accordance with another embodiment of the present invention;

FIG. 6 is a schematic transversal-sectional view of the essential portion of the wind turbine of FIG. 5;

FIG. 7 is a longitudinal-sectional view of an essential portion of an acceleration gear box of the wind turbine of FIG. 5;

FIG. 8 is a longitudinal-sectional view of an essential portion of a wind turbine in accordance with yet another embodiment of the present invention;

FIG. 9 is a longitudinal-sectional view of an essential portion of one conventional wind turbine; and

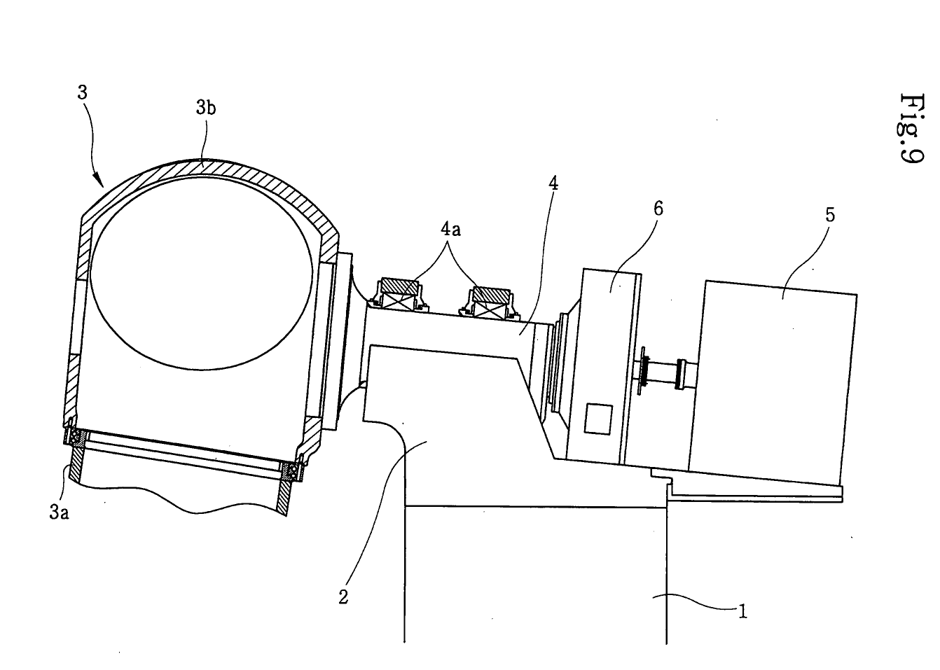

FIG. 10 is a longitudinal-sectional view of an essential portion of another conventional wind turbine.

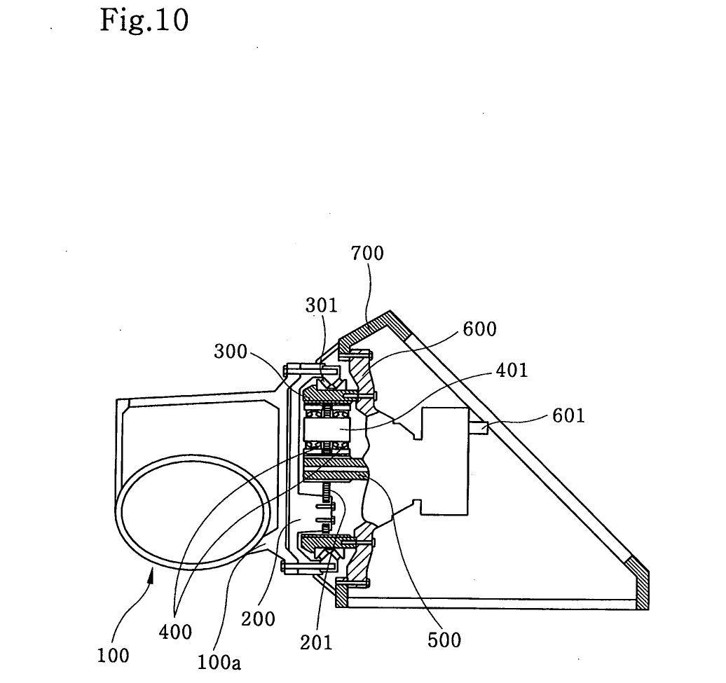

### BEST MODE

Now, preferred embodiments of the present invention will be described in detail with reference to the annexed drawings.

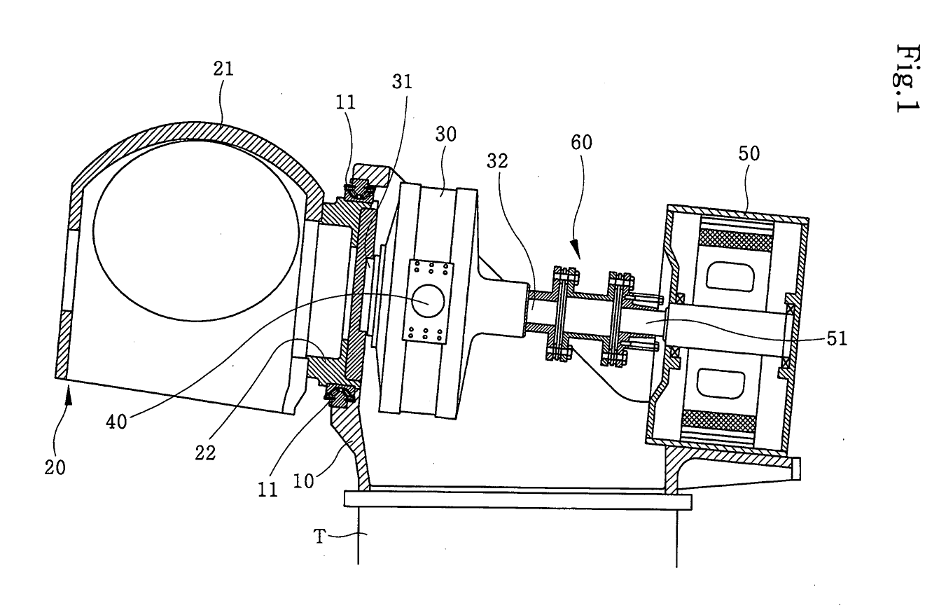

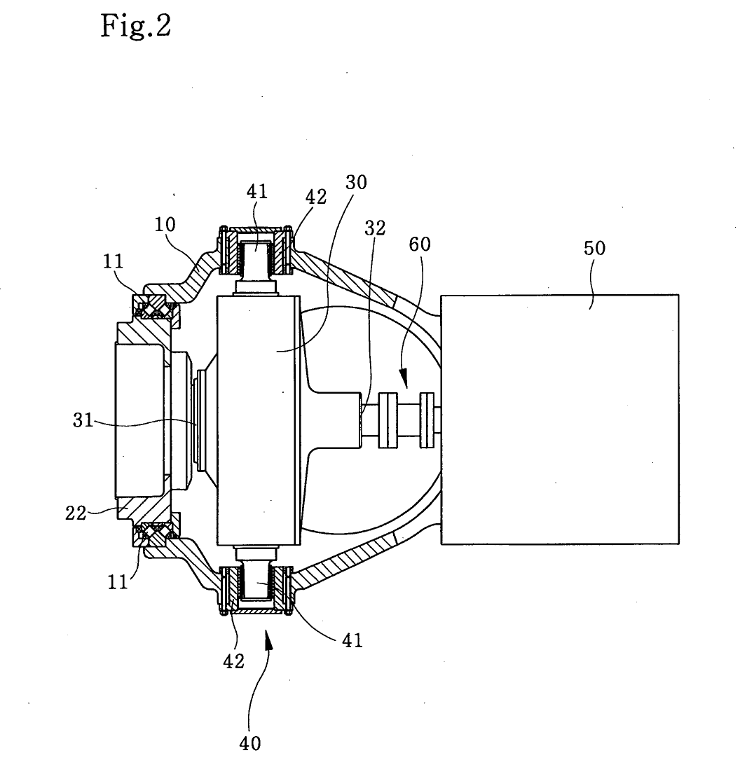

FIGS. 1 and 2 are longitudinal-sectional and transversal-sectional views of an essential portion of a wind turbine in accordance with one embodiment of the present invention, respectively.

As shown in FIGS. 1 and 2, a wind turbine of this embodiment includes a nacelle frame 10 having a single main bearing 11 on the front surface thereof, a rotor 20 including a rotor hub 21 provided with a hollow drum shaft 22, installed on the inner ring of the main bearing 11, at the rear thereof, an acceleration gear box 30 connected to the hollow drum shaft 22 and provided in the nacelle frame 10 under the condition that the acceleration gear box 30 is separated from the nacelle frame 10, a torque supporter 40 for preventing the acceleration gear box 30 from self-rotating, a generator 50 connected to the rear portion of the acceleration gear box 30, and a shaft coupling unit 60 for axially connecting the acceleration gear box 30 and the generator 50.

The nacelle frame 10 is rotatably installed at the upper end of a tower (T), and has the main bearing 11 installed on the front surface thereof. One main bearing 11 is installed on the nacelle frame 10, and serves to rotatably support the rotor 20 including the rotor hub 21 provided with the hollow drum shaft 22, installed on the inner ring of the main bearing 11, at the rear thereof.

That is, since the outer ring of the main bearing 11 is installed on the front surface of the nacelle frame 10, the main bearing 11 rotatably supports rotatably directly the hollow drum shaft 22 installed on the inner ring of the main bearing 11. Thereby, the rotor 20 including the rotor hub 21 provided with the hollow drum shaft 22 is installed on the front surface of the nacelle frame 10 under the condition that the rotor 20 is rotatably supported.

The hollow drum shaft 22 is rotatably supported by the nacelle frame 10 using the main bearing 11. Thereby, the acceleration gear box 30 connected to the hollow drum shaft 22 can be installed in the nacelle frame 10 under the condition that the acceleration gear box 30 is separated from the nacelle frame 10.

The rotor 20 is obtained by assembling blades with the rotor hub 21 provided with the hollow drum shaft 22, installed on the inner ring of the main bearing 11, at the rear thereof. As the blades assembled with the rotor hub 21 are rotated by wind, the rotor hub 21 is rotated and the hollow drum shaft 22 rotatably installed on the front surface of the nacelle frame 10 by the main bearing 11 is rotated simultaneously. Thereby, the hollow drum shaft 22 serves to transmit the rotary force to the acceleration gear box 30 connected to the hollow drum shaft 22.

The hollow drum shaft 22, which is rotatably supported by the nacelle frame 10 using the main bearing 11, serves to allow the rotor hub 21 to be rotatably supported by the nacelle frame 10 and to transmit the rotary force to the acceleration gear box 30, simultaneously.

The hollow drum shaft 22 may be provided integrally with the rear portion of the rotor hub 21, or be provided separately from the rear portion of the rotor hub 21 and be assembled with the rear portion of the rotor hub 21 by bolts.

The acceleration gear box 30 includes an input shaft 31 at the front portion thereof and an output shaft 32 at the rear portion thereof. The input shaft 31 is connected to the tip of the hollow drum shaft 22. The acceleration gear box 30 serves to transmit the rotation of the input shaft 31 to the outside through the output shaft 32 after the rotational speed of the input shaft 31, which is connected to the hollow drum shaft 22 and rotated together with the rotation of the hollow drum shaft 22, is increased.

Since the input shaft 31 is connected to the center of the inside of the hollow drum shaft 22 and the output shat 32 is connected to a rotary shaft 51 of the generator 50 by the shaft coupling unit 60, the above acceleration gear box 30 is provided in the nacelle frame 10 under the condition that the acceleration gear box 30 floats in the nacelle frame 10 so as to be separated from the nacelle frame 10.

The above structure of the acceleration gear box 30, which floats in the nacelle frame 10 so as to be separated from the nacelle frame 10, prevents the transmission of external force to the acceleration gear box 30 through the nacelle frame 10 and the transmission of external force to the nacelle frame 10 through the acceleration gear box 30 simultaneously.

That is, the load transmitted from the hollow drum shaft 22 is supported by the main bearing 11 installed on the nacelle frame 10, and only the rotary torque of the hollow drum shaft 22 is transmitted to the acceleration gear box 30 through the input shaft 31, thus effectively preventing the transmission of external force to the acceleration gear box 30 through the nacelle frame 10.

Therefore, the acceleration gear box 30 and parts connected thereto are not affected by the external force transmitted through the nacelle frame 10, and parts installed in the nacelle frame 10 are not affected by the acceleration gear box 30, thus improving the durability of the acceleration gear box 30.

The acceleration gear box 30 is easily assembled and disassembled in the nacelle frame 10 without disassembling all parts.

As the acceleration gear box 30 is easily assembled and disassembled, various parts including the acceleration gear box 30 are easily replaced and repaired, and thus the maintenance and management of the wind turbine is simply carried out.

The torque supporter 40 is installed between the outer surface of the acceleration gear box 30 and the inner surface of the nacelle frame 10, and serves to prevent the acceleration gear box 30, which floats in the nacelle frame 10 and is separated from the nacelle frame 10, from being rotated by the rotary torque transmitted from the rotor 20.

The above torque supporter 40 includes torque levers 41 protruded from both side surfaces of the acceleration gear box 30, and vibration absorbing dampers 42 assembled between the torque levers 41 and the nacelle frame 10.

The torque levers 41, each of which has one end installed on the outer surface of the acceleration gear box and the other end fixedly inserted into the nacelle frame 10, and thus serve to prevent the acceleration gear box 30 from self-rotating.

The vibration absorbing dampers 42 serve to prevent the transmission of vibration to the nacelle frame 10 through the acceleration gear box 30 and to prevent the transmission of vibration from the nacelle frame 10 to the acceleration gear box 30.

Preferably, the above vibration absorbing dampers 42 are made of synthetic resin so as to reduce the transmission of vibration generated from the acceleration gear box 30 to the nacelle frame 10. However, materials for the vibration absorbing dampers 42 are not limited thereto. That is, the vibration absorbing dampers 42 may be composed of various elements having a vibration absorbing ability, such as a spring, a hydraulic cylinder, and a pneumatic cylinder.

The generator 50 is provided with the rotary shaft 51 connected to the output shaft 32 by the shaft coupling unit 60, and serves to generate electricity by means of the rotation of the rotary shaft 51 together with the rotation of the output shaft 32.

The shaft coupling unit 60 is installed between the output shaft 32 and the rotary shaft 51, and serves to connect the output shaft 32 of the acceleration gear box 30 and the rotary shaft 51 of the generator 50 under the condition that an angle of deviation is allowed, to stably transmit the rotary force of the output shaft 32 to the rotary shaft 51.

That is, the shaft coupling unit 60 is a flexible coupling, which connects the output shaft 32 and the rotary shaft 51 under the condition that an angle of deviation can be formed. Thus, even through the output shaft 32 and the rotary shaft 51 deviate from each other so that an angle of deviation is formed therebetween, the rotary shaft 51 is stably rotated by the output shaft 32.

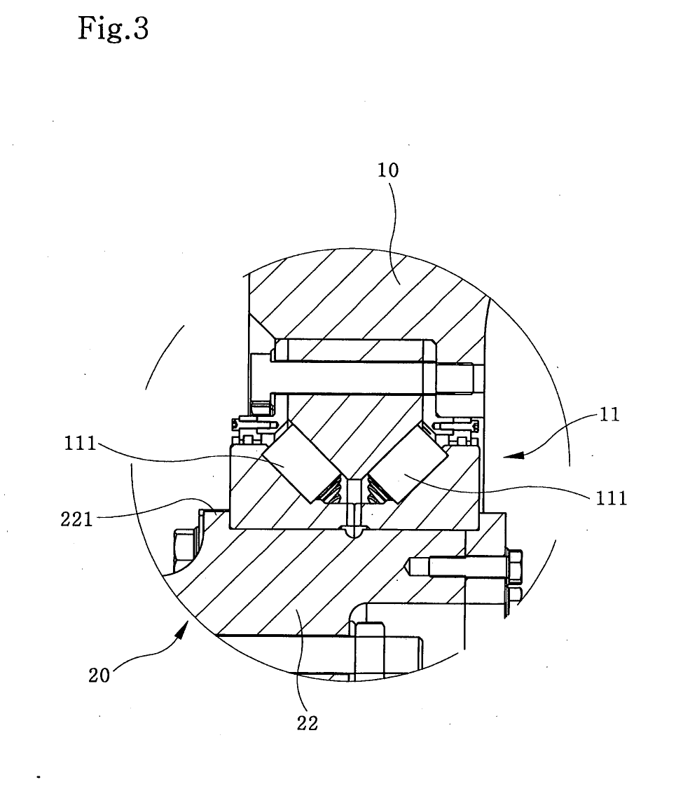

FIG. 3 is a sectional view of an essential portion of the main bearing in accordance with one embodiment of the present invention.

As shown in FIG. 3, the main bearing 11 installed on the nacelle frame 10 is a double-row taper roller bearing, the outer ring of which is assembled with the nacelle frame 10 by bolts, and the inner ring of which is assembled with the hollow drum shaft 22.

The main bearing 11 transmits the mechanical load of the rotor 20, transmitted through the hollow drum shaft 22, to the nacelle frame 10, and rotatably supports the rotary torque, generated from the rotor 20 and transmitted through the hollow drum shaft 22, through taper rollers 111, which are disposed in double rows in the main bearing 11, and transmits the rotary torque to the acceleration gear box.

As described above, a single main bearing 11, which is installed on the nacelle frame 10, transmits the mechanical load, transmitted from the rotor 20, to the nacelle frame 10, thus preventing the mechanical load generated from the rotor 20 from being transmitted to the acceleration gear box. Thereby, the acceleration gear box receives only the rotary torque generated from the rotor 20.

The hollow drum shaft 22 includes a support protrusion 221 protruded from the front end of the outer circumferential surface thereof. The support protrusion 221 serves to stably support the inner ring of the main bearing 11. The hollow drum shaft 22 is stably and easily assembled with the inner ring of the main bearing 11 by the support protrusion 221.

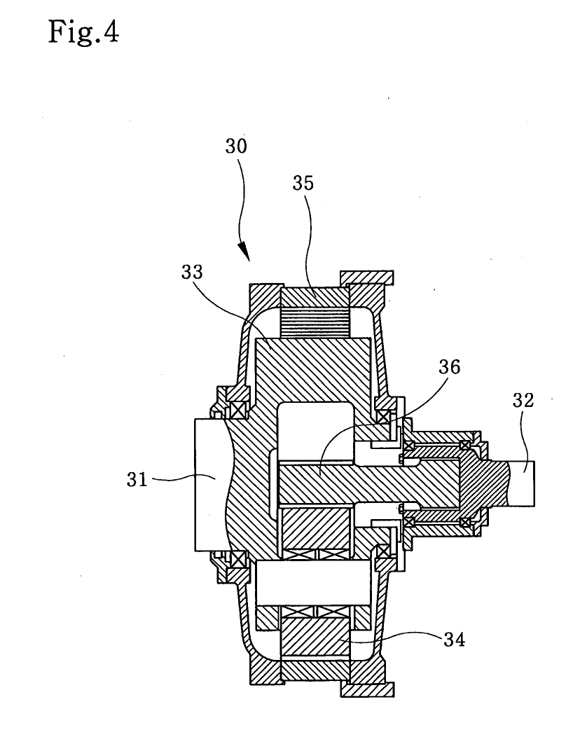

FIG. 4 is a longitudinal-sectional view of an essential portion of the acceleration gear box of the present invention.

As shown in FIG. 4, the acceleration gear box 30 includes the input shaft 31 provided at the front portion thereof so as to be exposed to the outside, the output shaft 32 provided at the rear portion thereof so as to be exposed to the outside, a gear housing 33 connected to the other end of the input shaft 31, a planetary gear 34 rotatably provided on the gear housing 33, an internal gear 35 engaged with the planetary gear 34, and a gear shaft 36 provided with one end engaged with the planetary gear 34 and the other end connected to the output shaft 32.

As the input shaft 31 of the acceleration gear box 30 is rotated, the gear housing 33 is rotated, and then the planetary gear 34 provided in the gear housing 33 is rotated along the internal gear 35. As the rotational speed of the planetary gear 34 increases, the gear shaft 36 engaged with the planetary gear 34 and the output shaft 32 connected to the gear shaft 36 are rotated under the condition that the rotational speeds of the gear shaft 36 and the output shaft 32 are increased.

As described above, the acceleration gear box 30 stably and precisely increases the rotational speed of the input shaft 31 in the first stage by means of the planetary gear 34 and the internal gear 35, and then transmits the rotation of the input shaft 31 to the outputs shaft 32.

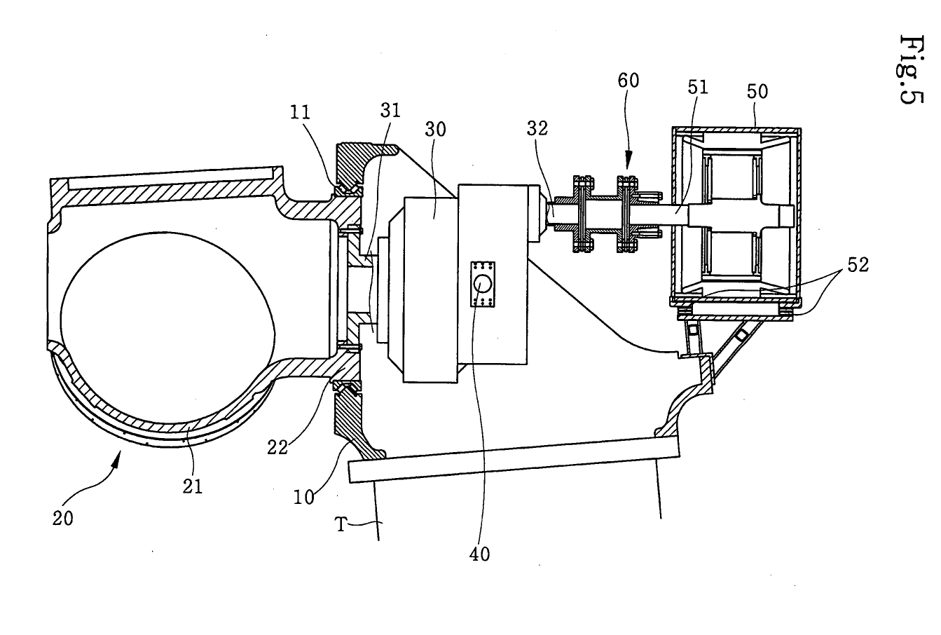

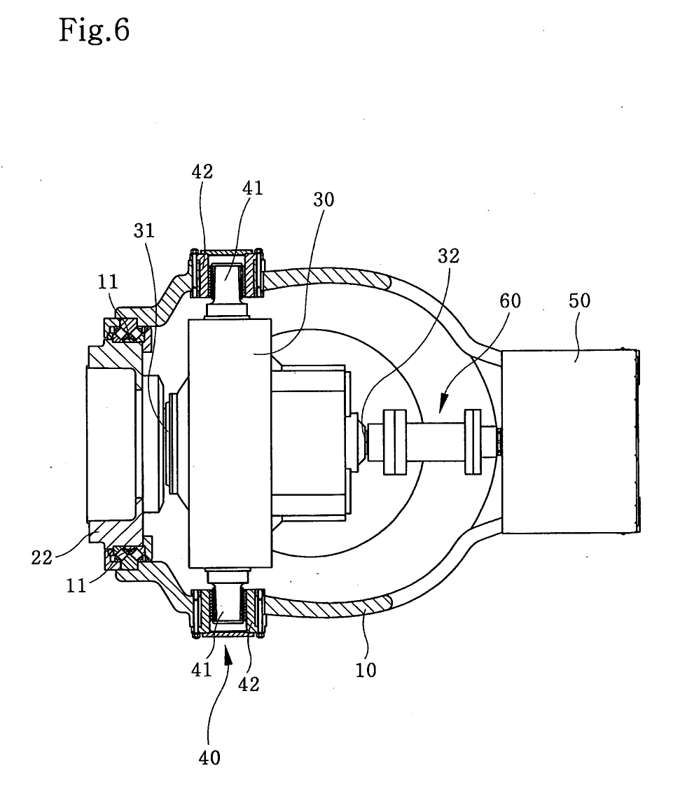

FIG. 5 is a longitudinal-sectional view of an essential portion of a wind turbine in accordance with another embodiment of the present invention, and FIG. 6 is a schematic transversal-sectional view of the essential portion of the wind turbine of FIG. 5.

As shown in FIGS. 5 and 6, a wind turbine in accordance with this embodiment includes a nacelle frame 10 having a single main bearing 11 on the front surface thereof, a rotor 20 including a rotor hub 21 provided with a hollow drum shaft 22, installed on the main bearing 11, at the rear thereof, an acceleration gear box 30 connected to the hollow drum shaft 22 and provided in the nacelle frame 10 under the condition that the acceleration gear box 30 is separated from the nacelle frame 10, a torque supporter 40 for preventing the acceleration gear box 30 from self-rotating, a generator 50 connected to the rear portion of the acceleration gear box 30, and a shaft coupling unit 60 for axially connecting the acceleration gear box 30 and the generator 50 so as to prevent the transmission of vibration between the acceleration gear box 30 and the generator 50.

The nacelle frame 10 is rotatably installed at the upper end of a tower (T), and serves to rotatably support the hollow drum shaft 22 through a single main frame 11 and stably hold the generator 50 provided at the rear thereof.

The main bearing 11 is installed on the nacelle frame 10, and directly supports the rotor 20 including the rotor hub 21 through the hollow drum shaft 22 installed on the inner ring of the main bearing 11 under the condition that the rotor 20 is rotatable. Thereby, the acceleration gear box 30 assembled with the hollow drum shaft 22 can be separated from the nacelle frame 10.

As blades assembled with the rotor hub 21 are rotated by wind, the rotor hub 21 is rotated, and the hollow drum shaft 22 installed thereon and supported by the front portion of the nacelle frame 10 is rotated simultaneously and serves to transmit the rotary force generated by wind to the acceleration gear box 30 assembled with the hollow drum shaft 22.

The acceleration gear box 30 serves to transmit the rotation of the input shaft 31 to the outside through the output shaft 32 after the rotational speed of the input shaft 31, which is rotated together with the rotation of the hollow drum shaft 22, is increased.

The acceleration gear box 30 includes an input shaft 31 at the front portion thereof and an output shaft 32 at the rear portion thereof. Since the input shaft 31 is connected to the center of the inside of the hollow drum shaft 22 and the output shat 32 is connected to a rotary shaft 51 of the generator 50 by the shaft coupling unit 60, the above acceleration gear box 30 is provided in the nacelle frame 10 under the condition that the acceleration gear box 30 floats in the nacelle frame 10 and is separated from the nacelle frame 10. Thereby, the acceleration gear box 30 and parts connected thereto are not affected by external force transmitted through the nacelle frame 10, and parts installed in the nacelle frame 10 are not affected by the acceleration gear box 30.

As the acceleration gear box 30 can be assembled and disassembled in the nacelle frame 10 without disassembling all parts, the acceleration gear box 30 is easily assembled and disassembled, and thus the acceleration gear box 30 and various parts including the acceleration gear box 30 are easily replaced.

The torque supporter 40 serves to prevent the acceleration gear box 30, which floats in the nacelle frame 10 and is separated from the nacelle frame 10, from self-rotating and to prevent the transmission of vibration from the acceleration gear box 30 to the nacelle frame 10 or from the nacelle frame 10 to the acceleration gear box 30.

The generator 50 includes the rotary shaft 51 connected to the output shaft 32 by the shaft coupling unit 60, and is installed on the upper surface of the nacelle frame 11. The generator 50 serves to generate electricity by means of the rotation of the rotary shaft 51 together with the rotation of the output shaft 32.

The generator 50 further includes generator dampers 52 installed between the lower surface of the generator 50 and the upper surface of the nacelle frame 10. The generator dampers 52 prevent vibration from being transmitted from the generator 50 to the nacelle frame 10 or from the nacelle frame 10 to the generator 50.

Preferably, the generator 50 is a permanent magnet synchronous generator. The permanent magnet synchronous generator does not require excitation, which is required by an asynchronous generator provided with a coil wound thereon, and thus improves convenience in operation.

The shaft coupling unit 60 is installed between the output shaft 32 and the rotary shaft 51, and serves to connect the output shaft 32 of the acceleration gear box 30 and the rotary shaft 51 of the generator 50 under the condition that an angle of deviation is allowed, to stably transmit the rotary force of the output shaft 32 to the rotary shaft 51 even in a deviation state.

Accordingly, the wind turbine of this embodiment allows the acceleration gear box 30 to be installed under the condition that the acceleration gear box 30 floats in the nacelle frame 10 and is separated from the nacelle frame 10, thus improving the durability and efficiency of the acceleration gear box 30 and allowing the acceleration gear box 30 to be easily disassembled and assembled when the acceleration gear box 30 gets out of order.

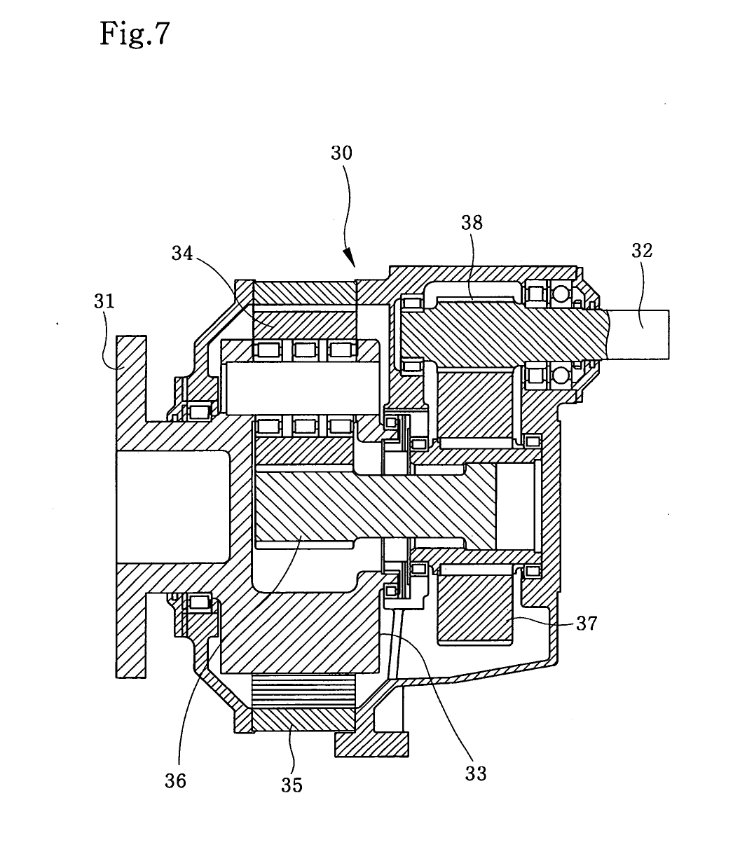

FIG. 7 is a longitudinal-sectional view of an essential portion of the acceleration gear box of the wind turbine of FIG. 5.

As shown in FIG. 7, the acceleration gear box 30 includes the input shaft 31 provided at the front portion thereof so as to be exposed to the outside, the output shaft 32 provided at the rear portion thereof so as to be exposed to the outside, a gear housing 33 connected to the other end of the input shaft 31, a planetary gear 34 rotatably provided on the gear housing 33, an internal gear 35 engaged with the planetary gear 34, a gear shaft 36 provided with one end engaged with the planetary gear 34 and the other end connected to the output shaft 32, a connection gear 37 connected to the tip of the gear shaft 36, and an acceleration gear 38 installed at the front end of the output shaft 32 so as to be engaged with the connection gear 37 and to be accelerated.

As the input shaft 31 of the acceleration gear box 30 is rotated, the gear housing 33 is rotated, and then the planetary gear 34 is rotated along the internal gear 35 and rotates the gear shaft 36 under the condition that the rotational speed of the gear shaft 36 is increased in a first stage.

As the gear shaft 36 is rotated in the above first stage, the connection gear 37 engaged with the gear shaft 36 is rotated and then the acceleration gear 38 engaged with the connection gear 37 is rotated under the condition that the rotational speed of the acceleration gear 38 is increased in a second stage, thus rotating the output shaft 32.

As described above, the acceleration gear box 30 firstly increases the rotational speed of the input shaft 31 by means of the planetary gear 34 and the internal gear 35, secondarily increases the rotational speed by means of the connection gear 37 and the acceleration gear 38, and then transmits the rotation of the input shaft 31 to the outputs shaft 32. Thereby, the rotary force of the input shaft 31 is increased in two stages, and is then transmitted to the output shaft 32.

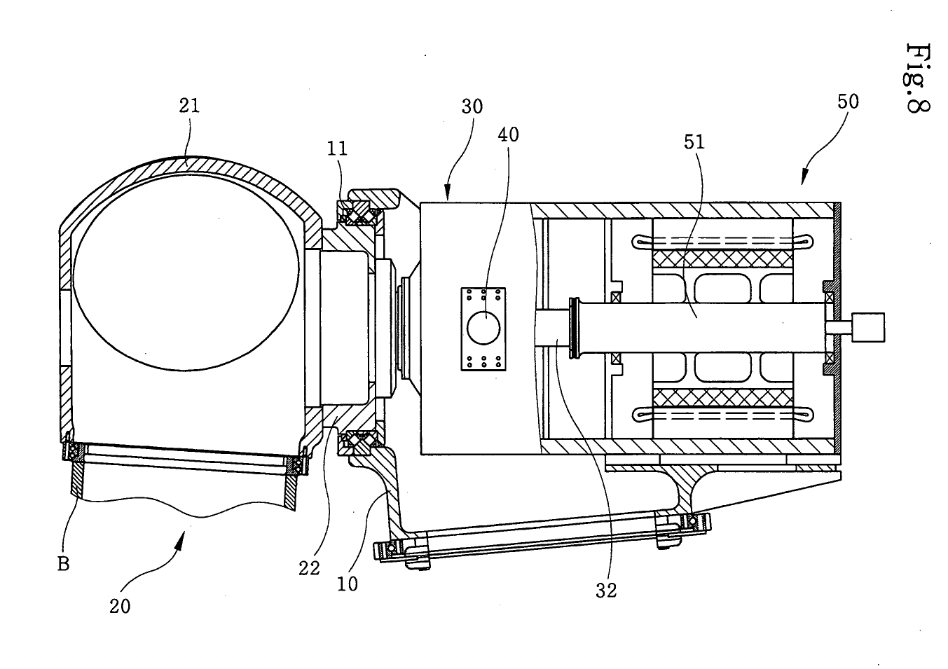

FIG. 8 is a longitudinal-sectional view of an essential portion of a wind turbine in accordance with yet another embodiment of the present invention.

As shown in FIG. 8, a wind turbine in accordance with this embodiment includes a nacelle frame 10 having a single main bearing 11 on the front surface thereof, a rotor 20 including a rotor hub 21 provided with a hollow drum shaft 22, installed on the main bearing 11, at the rear thereof, and blades (B) assembled therewith, an acceleration gear box 30 assembled with the hollow drum shaft 22 and provided in the nacelle frame 10 under the condition that the acceleration gear box 30 is separated from the nacelle frame 10, a torque supporter 40 for preventing the acceleration gear box 30 from rotating, and a generator 50 provided with a housing formed integrally with a housing of the acceleration gear box 30.

The housings of the acceleration gear box 30 and the generator 50 are formed integrally, the output shaft 32 of the acceleration gear box 30 and the rotary shaft 51 of the generator 50 are directly connected without a shaft coupling unit for removing an angle of deviation between the acceleration gear box 30 and the generator 50.

As describe above, the output shaft 32 of the acceleration gear box 30 and the rotary shaft 51 of the generator 50 are directly connected by bolts, thus preventing the generation of an angle of deviation between the output shaft 32 and the rotary shaft 51. Thereby, it is possible to prevent the increase of fatigue load of the output shaft 32 and the rotary shaft 51 due to the generation of the angle of deviation therebetween.

### INDUSTRIAL APPLICABILITY

As apparent from the above description, the present invention provides a wind turbine with a compact structure, which is simply assembled and disassembled and separates an acceleration gear box from a nacelle frame using a single main bearing, and thus transmits mechanical load from a rotor directly to the nacelle frame through the main bearing and transmits only rotary torque to the acceleration gear box so as to easily maintain and repair the acceleration gear box and stably and precisely achieve of the transmission of power, thus improving the durability and efficiency of the acceleration gear box.

The wind turbine of the present invention effectively prevents the acceleration gear box from self-rotating through a simple structure and reduces the vibration of the acceleration gear box, thus simply preventing the self-rotation of the acceleration gear box, and improving the stability in operation and remarkably reducing the generation of noise due to the reduction of the vibration.

The wind turbine of the present invention stably and precisely transmits rotary force between the acceleration gear box and the generator, thus preventing damages to shafts due to the instable transmission of rotary force.

The wind turbine of the present invention stably and effectively achieves the acceleration, i.e., the increase of the number of rotations, through a planetary gear, thus stably achieving an accelerating operation as reducing the wearing away and breakage of teeth of gears due to excessive acceleration.

The wind turbine of the present invention allows housings of an acceleration gear box and a generator to be formed integrally so as to stably transmit rotary force without any separate shaft coupling unit and simply install and assemble the acceleration gear box and the generator, thus preventing the increase of fatigue load due to an angle of deviation and being simply installed and assembled in a short period of time.

The wind turbine of the present invention prevents vibration from being transmitted between the generator and the nacelle frame, thus preventing damages to parts due to vibration, reducing noise, and lengthening the life span of the generator.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-11. (canceled)

12. A wind turbine with a single main bearing, comprising:
a nacelle frame provided with one main bearing on the front surface thereof;
a rotor including a rotor hub provided with a hollow drum shaft, installed on the inner ring of the main bearing, at the rear thereof;
an acceleration gear box including an input shaft, connected to the tip of the hollow drum shaft, at the front portion thereof and an output shaft at the rear portion thereof, and floating in the nacelle frame under the condition that the acceleration gear box is separated from the nacelle frame for increasing the rotational speed of the input shaft and transmitting the rotation of the input shaft to the output shaft;
a torque supporter installed between the acceleration gear box and the nacelle frame for preventing the acceleration gear box from self-rotating;
a generator including a rotary shaft connected to the output shaft; and
generator dampers installed between the lower surface of the generator and the upper surface of the nacelle frame so as to prevent vibration from being transmitted between the nacelle frame and the generator.

13. The wind turbine according to claim 12, wherein the acceleration gear box further includes:
a gear housing connected to the other end of the input shaft;
a planetary gear eccentrically and rotatably connected to the inner surface of the gear housing;
an internal gear, the inner surface of which is engaged with the outer surface of the planetary gear so that the planetary gear is rotated together with the rotation of the gear housing; and
a gear shaft provided with one end engaged with the inner surface of the planetary gear and the other end connected to the output shaft; and
is accelerated in a first stage by the planetary gear.

14. The wind turbine according to claim 13, wherein the acceleration gear box further includes:
a connection gear connected to the tip of the gear shaft; and
an acceleration gear installed at the front end of the output shaft so as to be engaged with the connection gear and be accelerated; and
is accelerated in a second stage by the acceleration gear.

15. The wind turbine according to claim 12, wherein the torque supporter includes:
torque levers protruded from both side surfaces of the acceleration gear box and fixed to the nacelle frame; and
vibration absorbing dampers assembled with the torque levers so as to prevent the vibration of the acceleration gear box from being transmitted to the nacelle frame.

16. The wind turbine according to claim 15, wherein the vibration absorbing dampers are made of synthetic rubber so as to reduce transmission of the vibration generated from the acceleration gear box to the nacelle frame.

17. The wind turbine according to claim 12, further comprising a shaft coupling unit installed between the output shaft and the rotary shaft so as to achieve transmission of rotary force therebetween under condition that an angle of deviation is allowed.

18. The wind turbine according to claim 12, wherein the acceleration gear box and the generator are integrally formed such that housings of the acceleration gear box and the generator are assembled integrally and installed in the nacelle frame.

19. The wind turbine according to claim 12, wherein the main bearing is a double-row taper roller bearing.

20. The wind turbine according to claim 12, wherein the generator is a permanent magnet synchronous generator.

21. The wind turbine according to claim 12, wherein the hollow drum shaft includes a support protrusion protruded from the front end of the outer circumferential surface thereof so as to support the inner ring of the main bearing.
